(19) United States
(12) Patent Application Publication
(10) Pub. No.: US 2001/0047391 A1
(43) Pub. Date: Nov. 29, 2001

(54) Forwarding electronic mail and messages to internet destinations linked with pre-existing unique identifier

(76) Inventor: Kehyeh Szutu, Palo Alto, CA (US)

Correspondence Address: Bo-In Lin, 13445 Mandoli Drive, Los Altos Hills, CA, 94022, US

(21) Appl. No.: 09/815,642

(22) Filed: Mar. 23, 2001

Related U.S. Application Data
(60) Provisional application No. 60/192,141, filed on Mar. 23, 2000.

(51) Int. Cl. G06F 15/16

(52) U.S. Cl. 709/206

(57) ABSTRACT

The present invention discloses network system. The network system includes a unified access management center comprises a database for storing paired data for linking a network-independent preexisting-unique identifier to an e-mail forwarding address. In a preferred embodiment, the unified access management center further comprises an incoming e-mail processor for processing an incoming e-mail address comprises information related to the network-independent preexisting-unique identifier for searching the database for providing the forwarding e-mail address stored in the database. In a preferred embodiment, the unified access management center further comprises a unified access registration processor for receiving a registration request comprises a network-independent preexisting-unique identifier and an associated forwarding e-mail address for storing in the database.

This Application claims a Priority Date of Mar. 23, 2000, benefited from a previously filed Provisional Application 60/192,141 filed on Mar. 23, 2000 by the same Applicant of this Patent Application.

### BACKGROUND OF THE INVENTION

1. Field of the Invention

This invention relates generally to network systems for various kinds of communications. More particularly, this invention relates to an improved system configuration and method for interactively linking a network-independent unique identifier, typically a preexisting unique identifier such as a telephone number, to an electronic mail (e-mail) address to practically realize a simplified and unified access.

2. Description of the Prior Art

As commented in US News and World Report published on Mar. 6, 2000, that technology is always complicating life in an effort to simplify it. The new article continues with the observation that the ability to work from anywhere sounds great until the need to juggle scads of numbers, such as office phone, home phone, cell phone, pager, fax, and then different e-mail addresses for different accounts use for different purposes. The article then reported that there are several Internet services to provide Web sites allow for unified messaging. The Web sites are set up to resolve the problems by simplifying and, to certain degree, unifying the message delivering processes. Examples of such unified messaging sites. include www.onebox.com, www.messageclick.com, and www.jfax.com. The theme is to provide universal in-box on the Web to deliver faxes, e-mails, and voice mails.

These Internet services for unified messages still face several limitations and difficulties. As a user signs up with these services, a telephone number is assigned. A fax sent to this number is routed to a private Web page or e-mail account that the user can access. Voice mails work the same way by that the audio message is sent to a private Web site or as e-mail that a user can download and play using an audio player. However, since the service is not available in certain areas, the phone number assigned to a user may be of a different area code than where the user resides or works. Meanwhile for an incoming telephone call, a caller has to wait for the unified access provider to first check with a user to first ask if the user is available or willing to answer the call. A caller to that unified access number can easily get frustrated for the long pauses.

As a matter of facts, various telephonic technologies already provide some solutions to the message delivery limitations. A telephone number can be easily applied for receiving an incoming telephone call or a fax transmission. Call forwarding options are available to forward the call to an office telephone or pager. Such operations can even be remotely operated. As far as telephonic communications are concerned, a user is provided with sufficient resources and flexibility to unify the message delivery processes to certain extent if a telephonic user decide to do so. The major issues often encountered are mostly due to other concerns such as the consideration of privacy that a telephone user may not want to provide the home phone numbers in exchanging a business card. A home phone number, pager number or a cellular phone number are typically revealed to only limited number of peoples when necessary. For the consideration of privacy, the “unified messaging” services, if with all difficulties completely resolved in the future, will be mostly likely used in the business world. Separate private numbers for limited accesses will still be maintained because of other reasons.

For business operations, there is however a major trend that greatly adds to the complexities of message delivery. Specifically, more and more communications are now conducted on Internet with electronic mails (e-mails). The e-mail addresses for sending and receiving Internet communications become another important set of identifiers for message delivery. These e-mail addresses have different lengths and often comprise numbers and alphabets or even unusual characters. E-mail addresses usually can not easily remembered. Furthermore, as indicated above, each person may have several e-mail addresses for different accounts and different purposes. Access and message delivery become even more complex due to the situation of Internet communications. The unified messaging services discussed above do not seem to address this complexity that additional e-mail addresses now become another set of identifier associated with each personal now required to access and deliver messages.

Therefore, a need still exists in the art of network for providing a new and improved configuration and method to overcome these limitations. The improved configuration and method must provide simplified and practical Internet access for sending and receiving e-mails without further complicating the message deliver processes.

### SUMMARY OF THE PRESENT INVENTION

It is therefore an object of the present invention to provide a system configuration and method to simplify the access mechanism for e-mail message delivery on Internet. A database for linking a set of stored programs, which could be email forwarding programs with associated email addresses, to a existing unique identifier is disclosed to simplify the access process of e-mail message exchanges and to further extend the functions that can be accomplished through email. By providing a database with such linking, a person of ordinary skill in the art is enabled to overcome the aforementioned difficulties and limitations encountered in the prior art and do much more with existing email.

Specifically, it is an object of the present invention to provide a new method and system configuration with a unified access management center provided with database accessible by an Internet user through a registration process. The unified access management center further included an electronic mail processor for receiving e-mails sent with a unified access number associated with an pre-existing identifier such as a telephone number. The unified access management center then searches the database to find a data item to match with the preexisting identifier to determine a “forwarding e-mail address or addresses” or functions to be accomplished through stored program. The incoming e-mail to the unified access management center is then forwarded to the forwarding e-mail address or addresses or the unified access management center activates stored program to perform some functions as registered in the database. The incoming e-mail may also be stored locally in the unified access management center. A registered user providing the preexisting identifier through a registration process can then retrieve the stored e-mails. With a simple search and e-mail forwarding mechanism, the e-mail address is simply provided on a business card as a regular telephone number such as MailAttel:123-456-7890 where 123-456-7890 is an exemplary telephone number and 123-456-7890@MailAttel.com can be used as an e-mail address where MailAttel.com is an exemplary domain name. The unified access management center further has a normalizing processor to normalize variations of the user name part of the e-mail addresses such as (123)456-7890@MailAttel.com, (123)4567890@MailAttel.com, 11234567890@MailAttel.com, etc. The preexisting identifier used as user name of the e-mail address may also be specified with extensions. The registered users have complete control on the setup of the extensions to map them to his local entities. The extensions do not have to be a real phone extensions. The extension can be applied to further forward the e-mails to different accounts when necessary such as a family sharing a common telephone number with multiple e-mail accounts or employees in a company each has a different extension number and e-mail address. With normalization process, a user does not have to input the user name of the e-mail address, i.e., the preexisting identifier specified by the ten digit number as shown above, as exact as now required by a conventional Internet Service Provider (ISP). This exact ID requirement for conventional Internet Service Provider (ISP) is necessary because a conventional e-mail address can have many different combinations of numbers and characters. With a normalization function provided in the unified access management center, some of the requirements for exact e-mail address input matching with the registered user address ID is also circumvented.

Another object of the present invention is to provide a new method and system configuration by providing a unified access management center provided with database accessible and editable by a registered user. The registered user has a flexibility to change the stored programs or forwarding e-mail addresses by simply changing the database. The requirement to inform every e-mail correspondents about a change of e-mail address is no longer necessary. Additionally, the database may also provide additional control for forwarding e-mails to different accounts depending on different group of e-mail senders. The burden to provide and then keep track of different e-mail addresses to different groups of people is therefore relieved. By re-editing the database, a registered user is able to control the functions that are carried out when an email is received.

Briefly, in a preferred embodiment, the present invention discloses network system. The network system includes a unified access management center comprises a database for storing paired data for linking a network-independent preexisting-unique identifier with or without local extensions to e-mail forwarding address or stored programs. In a preferred embodiment, the unified access management center further comprises an incoming e-mail processor for processing an incoming e-mail address comprises information related to the network-independent preexisting-unique identifier for searching the database for providing the stored programs or forwarding e-mail address stored in the database. In a preferred embodiment, the unified access management center further comprises a unified access registration processor for receiving a registration request comprises a network-independent preexisting-unique identifier with or without local extensions and an associated stored programs or forwarding e-mail address for storing in the database. In a preferred embodiment, the incoming e-mail processor further comprises an incoming e-mail address normalizing means for normalizing and converting an e-mail address of the incoming e-mail into a normalized incoming e-mail address. In a preferred embodiment, the network system further comprises a request intent processor to carry out the stored program. In the case where the stored program is for email forwarding, then the intent processor is an e-mail forward means for forwarding an incoming e-mail to an e-mail forwarding address retrieved from the database associated the incoming e-mail address.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is a functional block diagram showing an architecture overview of a system configuration for the present invention.

FIG. 2 shows a functional block diagram of a registration process for a unified access number registration and building up an e-mail forwarding address database 150;

FIG. 3 is a functional block diagram of a unified access management center provided with database for forwarding an incoming e-mail sent with a network-independent unique identifier to an e-mail forwarding address or carrying out stored program;

FIG. 4 is a flow chart showing the functional steps carried out by the unified access management center to apply a normalized user name for searching database and for linking and forwarding an e-mail to an associated e-mail address or carrying out stored program.

### DETAILED DESCRIPTION OF THE PREFERRED EMBODIMENT

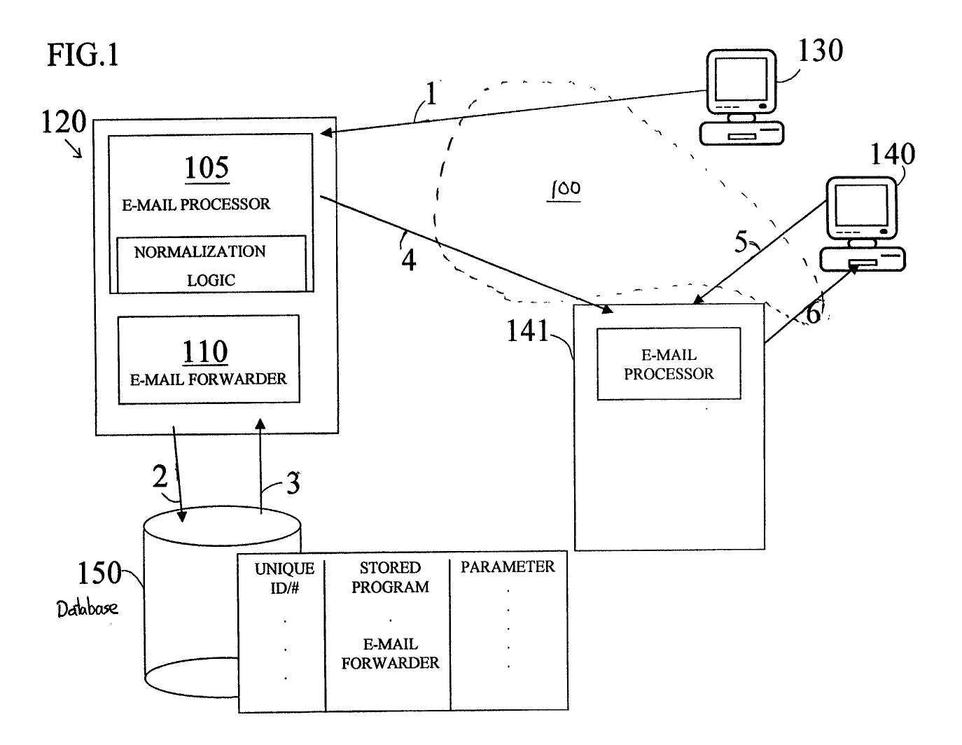

Referring to FIG. 1 for a functional block diagram showing an architecture overview of a system configuration for the present invention. The network communication system, e.g., an Internet system 100, includes a unified access management center 120. In a preferred embodiment, this unified access management center 120 is implemented as an Internet control Web server and or mail server. The unified access management center 120 is connected to and in communication with an Internet user 130 to send an e-mail to another Internet user 140 assigned with a specific e-mail address on the Internet. The unified access management center 120 includes an incoming e-mail processor 105 and an e-mail forwarder 110. The Internet user 13O sends an electronic mail to the unified access management center 120, e.g., reached through MailAttel.com, addressed to a unified access identifier of that access management center, such as 123-456-7890@MailAttel.com, where 123-456-7890 is the unified access identifier, functions as a virtual user name of an e-mail address. The unified access identifier, e.g., 123-456-7890, sent by the incoming e-mail is an Internet-independent unique identifier to identify and link to a forwarding email address of another Internet user 140. This unique identifier is preferably a unique number that is provided by an external, independent administrative authority, e.g., a telephone number, a social security number, a tax identification number, a driver's license number, etc. The Internet user 140 to which the e-mail is directed preferably has a unique association with the unique identifier, e.g., when a phone number is used as the unique identifier that telephone number is the number of the owner of that Internet user 140. The incoming e-mail processor 105 further includes a incoming e-mail address normalization logic that could be implemented as software or a hardware component of the incoming e-mail processor 105. After the unified access management center 120 receives the e-mail, the incoming e-mail processor 105 performs a normalization to convert the user name of the e-mail address of the incoming e-mail, i.e., the unique identifier, into a normalized incoming e-mail address. Then the incoming e-mail processor 105 accesses a database 150 to perform a database search to match a normalized incoming e-mail address, i.e., a normalized unique identifier, with a stored program which could be an email forwarding program with e-mail forwarding address. When an e-mail forwarding program is matched with the normalized unique identifier, the incoming e-mail is then forwarded to the matched forwarding e-mail address. Using that matched forwarding address, the Internet user 13O is able to send an e-mail to the Internet user 140 identified by an unique identifier which is a unified access number for the Internet user 140. When the unified access number of the Internet user 140 is a telephone number, then a telephone number is employed as a unified access number for making a telephone call and for sending e-mail to the Internet user 140. Since the Internet-independent identifier, e.g., a telephone number is uniquely assigned to the Internet user 140, there is no concern of duplication thus can be conveniently used as a unified access identifier for making telephone call and for sending e-mails. In another preferred implementation, the normalization process can also be delayed from the previously described and carried out only if a match of the incoming email address can not be found in database 150. In yet another preferred implementation, the normalization can be carried out as a combination of the previously described.

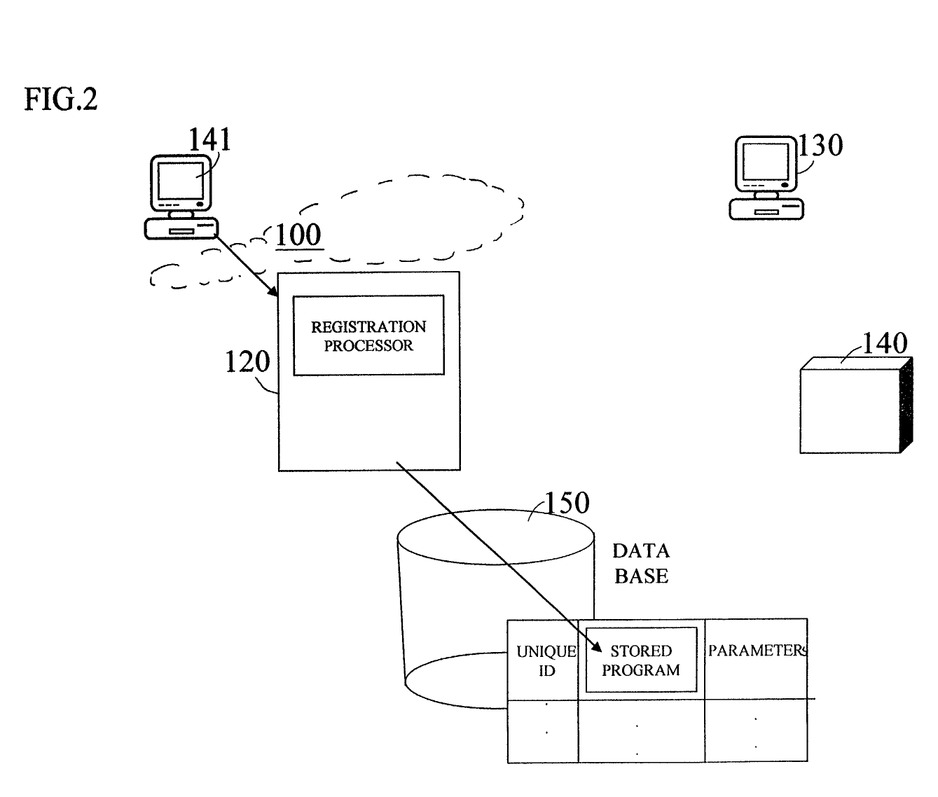

FIG. 2 is a functional block diagram of a registration process for a unified access number registration and building up stored programs, which could be email forwarding programs with e-mail forwarding address, database 150. To register with the unified access management center 120, an Internet user 140 may first contact registration process, which could be the Web page managed by a registration server of the unified access management center 120. The Internet user 140 then provides an network-independent preexisting-unique identifier, e.g., a telephone number, with or without local extensions and associated stored programs, which could be email forwarding programs with forwarding e-mail address or several forwarding e-mail addresses, to the unified access management center 120. The Internet user 140 can also associate stored programs with this unique identifier. After the unified access management center 120 receives the Internet-independent unique-identifier that preferably is a preexisting identifier such as a telephone number and the associated stored programs, the unified access management center 120 stores the telephone number paired with the stored programs, which could be email forwarding programs with forwarding e-mail addresses, received from the Internet user 140. With these pairs stored in the database 150, pointers are stored for linking the network-independent preexisting-identifier to the forwarding e-mail address or to the stored program and parameters stored in the database 150 as associated pairs.

In the meantime, the unified access management center 120 sets up an incoming e-mail input means that may be a mail server capable of processing the POP, Simple Mail Transfer Protocol (SMTP) or other mail protocols for network communication with mail server 141. These servers 141 are there to receive from or deliver to an Internet user 140 electronic mail (e-mail). The incoming e-mail is sent to the unified access management center 120 with an e-mail destination identified by a telephone number, a cellular phone or a pager number associated with Internet user 140, which are ready to receive e-mails from the Internet. As the unified access management center 120 received the e-mail from the Internet user 130 with destination identified by a telephone number of the Internet user 140, a database search is conducted to find the stored programs, which could be email forwarding programs with forwarding e-mail addresses of the Internet user 140. The e-mail sent from the Internet user 130 can be either stored in a mailbox locally to be retrieved by Internet user 140 or sent through a mail server 141 to be retrieved by the Internet user 140.

As described above, the Internet user 130 may enter this Internet-independent preexisting-unique identifier with some degrees of flexibility. For example, the telephone number may be entered with or without a prefix “1” for a long distance number or may even be entered without an area code if it is a local number for the Internet user 130 and the area code can be discovered by the unified access management center 120. The incoming e-mail processor 105 can then normalizes and converts the Internet-independent preexisting-unique identifier into a normalized unique identifier, e.g., a normalized telephone number, to carry out a database search for finding out stored program or an associated forwarding e-mail address.

As that disclosed in FIGS. 1 and 2, this invention discloses a network system 100. The network system includes a unified access management center 120 comprises a database 150 for storing paired data for linking a network-independent preexisting-unique identifier with or without local extensions to stored programs which could be email forwarding programs with an e-mail forwarding address. In a preferred embodiment, the unified access management center 120 further comprises an incoming e-mail processor 105 for processing an incoming e-mail comprises information related to the network-independent preexisting-unique identifier for searching the database 150 for providing a linked stored program which could be email forwarding program with forwarding e-mail address stored in the database 150. In a preferred embodiment, the unified access management center 120 further comprises a network-resource registration processor for receiving a registration request comprises a network-independent preexisting-unique identifier and stored programs which could be email forwarding program with associated forwarding e-mail address for storing in the database. In a preferred embodiment, the network-resource request-input processor further comprises an incoming e-mail normalizing means for normalizing and converting the unique identifier as a destination of the incoming e-mail-into a normalized unique identifier constituting a normalized destination e-mail address. In a preferred embodiment, the incoming e-mail processor further comprises an e-mail destination address processing means for receiving and processing an incoming e-mail directed to an e-mail destination address identified by the unique identifier. In a preferred embodiment, the unified access management center 120 further comprises a request intent processor 110 for carrying out the registered stored program. When the stored program is a a mail forwarding program, 110 becomes an e-mail forward means for forwarding an incoming e-mail to an e-mail forwarding address retrieved from the database to a Internet user 140.

According to FIGS. 1 and 2, this invention discloses a method for activating stored program using emails. When the intent of the stored program is to forwarding emails the FIGS. 1 and 2 discloses a method for generating forwarding e-mail address for sending an e-mail from a sending Internet User 130 to a receiving Internet user 140. The method comprising steps of a) the sending Internet user 130 providing an user-input Internet-independent unique identifier related to the receiving Internet user 140 to an unified access management center 120; and b) the unified access control center searches a database 150 to find an e-mail forwarding address associated with the Internet-independent unique identifier for generating the forwarding e-mail address for forwarding the e-mail sent from the sending Internet user 130 to the receiving Internet user 140. In a preferred embodiment, the step a) of the sending Internet user 130 providing a user-input Internet-independent unique identifier is a step a1) of the Internet user 130 providing the user-input Internet-independent unique identifier as a user name of a destination address of the receiving Internet user 140. In a preferred embodiment, the step b) further comprising a step b1) of the unified access management center 120 converting the user-input Internet-independent unique identifier to a normalized Internet-independent unique identifier of the receiving Internet user 140 for the unified access management center 120 to search a database 150 to find an e-mail forwarding address associated with the normalized Internet-independent unique identifier for generating the forwarding e-mail address for forwarding the e-mail to the receiving Internet user 140. In a preferred embodiment, the step a) of the sending Internet user providing an Internet-independent unique identifier is a step a2) of the sending Internet user providing a telephone number of the receiving Internet user 140 as a user name of the destination e-mail address. In a preferred embodiment, the step a) of the sending Internet user providing a user-input Internet-independent unique identifier is a step of the sending Internet user providing the user-input Internet-independent unique identifier as a advertisement identifier number of the receiving Internet user. In a preferred embodiment, the step a4) of the Internet user providing the user-input Internet-independent unique identifier as an advertisement identifier number corresponding to the receiving Internet user is a step a5) of inputting the advertisement identifier number as an e-mail destination address at the domain name of the unified access management center 120. In a preferred embodiment, the step a) of the Internet user providing a user-input Internet-independent unique identifier is a step a6) of the Internet user providing the user-input Internet-independent unique identifier as a branch location name of the receiving Internet user. In a preferred embodiment, the step a6) of the Internet user providing the user-input Internet-independent unique identifier as an branch location name of the receiving Internet user is a step a7) of inputting the branch location name as an e-mail destination address at an Internet domain name of the unified access management center.

In summary, this invention discloses a network system comprises a unified access management center 120 provided with an interactive database 150 for enabling an Internet user 140 to editing an unique linking pointer for linking to an e-mail forwarding address directed to said Internet user 140. Internet user 140 can also put stored program(s) in the database 150.

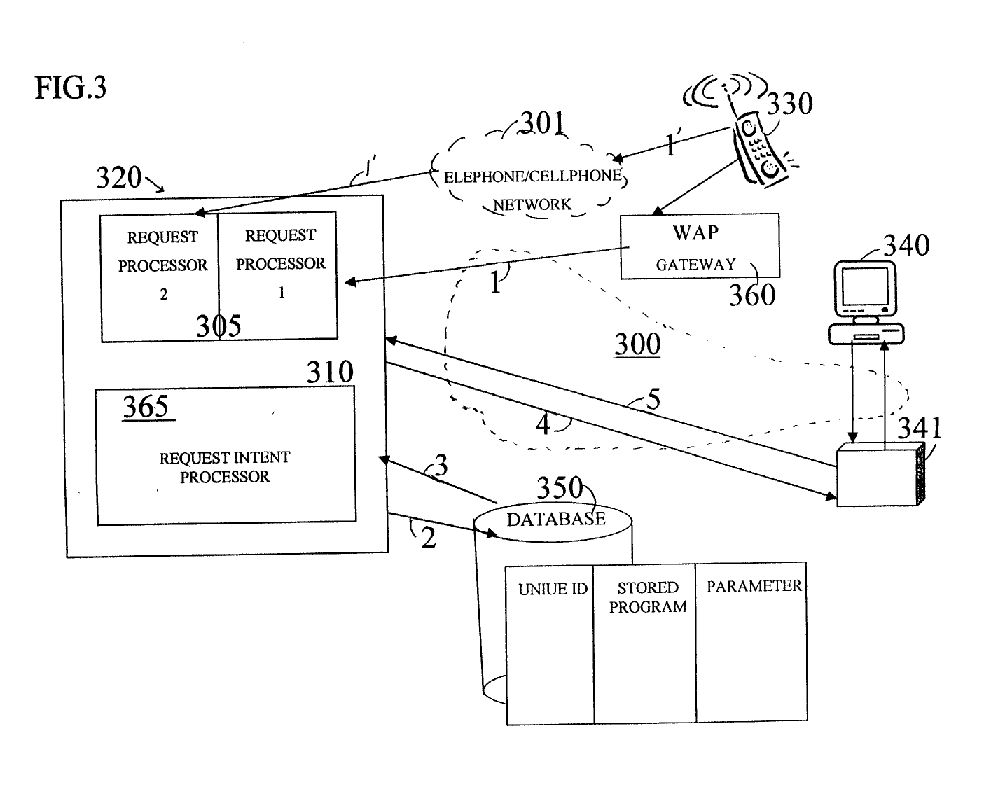

Referring to FIG. 3 for a functional block diagram showing an architecture overview of another system configuration of this invention. The network communication system, e.g., an Internet system 300, includes a unified access management center 320. In one of the preferred embodiments, this unified access management center 320 can be implemented as an Internet control Web site and/or Internet email server site. The unified access management center 320 is connected to and in communication with a wireless Internet telephone user 330 via the Internet 300. The wireless Internet telephone user 330 is communicating with the Internet system 300 via a wireless application protocol (WAP) gateway 360 or other types of gateways for transmitting an e-mail to an Internet e-mail receiver 340. WAP and WAP gateway are used here for illustrating one of the possible way for a cell phone to access the unified access management center 320 and should not be interpreted as limiting. The unified access management center 320 includes an incoming e-mail processor 305 and an e-mail forwarder 310. In a more generic description, 305 is the request processor with part 1 handling email input and part 2 handling telephone input. The email forwarder 310 is a special case of the request intent processor 365 when the request intent is forwarding the email. The wireless-Internet user 330 sends an e-mail to the unified access management center 320 through the WAP gateway 360 via the Internet 300. The e-mail designates a destination address preferably include an Internet-independent identifier such as a specific telephone number. This telephone number may be one of the numbers already stored as a “speedy dialing number” such that the wireless Internet user 330 can simply push one button to send out the message. The network-independent identifier may be an identifier to identify and link to a receiving Internet user 340, e.g., an e-mail to Charles Schwab Stock broker that has an unique association with the identifier such as an (800) free-access phone number. Alternatively, the network requester 330 may send the e-mail from a micro-browser via the WAP to reserve a hotel room with the reservation agent as a receiving Internet user 340. The incoming e-mail processor 305 further includes an incoming e-mail address normalization logic that could be implemented as software or a hardware component of the incoming e-mail processor 305. After the unified access management center 320 receives the incoming e-mail, the incoming e-mail processor performs a normalization to convert the destination address into a normalized destination address as an unique identifier. In another implementation, the normalization can also be delayed to later after a match could not be found in the database 350. Then the incoming e-mail processor 305 accesses a network resource database 350 to perform a database search to match the normalized destination address with a stored program which could be email forwarding program with an e-mail forwarding address. If the normalized destination address is matched to an e-mail forwarding address, the e-mail is sent either directly or through an e-mail server 341 to the matched forwarding e-mail address associated with the Internet user 340. Using that matched forwarding e-mail address, the wireless Internet user 330 is enabled to send the e-mail to another Internet user 340 by dialing in the phone number of the Internet user 340 as an unique identifier. A wireless telephone user with features to access the Internet can simply dial a speedy dial number by pressing two buttons to send instructions to user's own stock broker without having to type in long sting of characters and names representing broker's e-mail address.

The wireless telephone user 330 has an alternate option of contacting unified access management center 320 by making a telephone call through a telephone or cellular phone network 301 to the unified access management center 320. The same procedure will work also for normal land line phone too. The part 2 of the request processor 305 handles the incoming call just like a PBX attendant. It can accept digit input after the call is answered by 305. In one implementation, the digits immediately followed could be the unique identifier or the unique identifier with extension associated with an Internet user 340. The processor 305 normalizes the unique identifier associated with 340 and then searches the database 350 to retrieve the stored program and parameters associated with this unique ID and extension. The retrieved stored program and parameters are then passed to 365 request intent processor to decide what action needs to be taken and carry out the intent. In the case where the intent is to turn on the heater at the building with that phone number as unique ID, the stored program will be passed to 365 and send out commands to turn on the heater. In the case where the stored program requests a voice mail message be sent to Internet user 340 associated with this unique ID then the telephone user 330 has an option to record a message and be sent to user 340 through mail or other intended method as described by the stored program. In yet another implementation where 320 has a generic set of services, and one of the generic service is sending a voice attachment in an email to another Internet user. The wireless telephone user 330 has an option to record a phone-mail message recorded by the unified access management center 320. After the phone mail message is recorded, the wireless telephone user can then enter a telephone number of an Internet user 340. The telephone number of Internet user 340 is employed to search a forwarding e-mail address to forward the record phone mail message to the Internet user 340 as an audio file. In yet another implementation where 340 is a building with Internet connection and the telephone number is the main access phone number of the building. A virtual extension, i.e. extension not in the PBX system but exist for the purpose of activating stored program in unified access management center 320, can be associated with stored program to turn on the lights or turn off the lights. Any users who can send email to or use telephone to contact Unified access management center 320 can now turn on and off the light of the building.

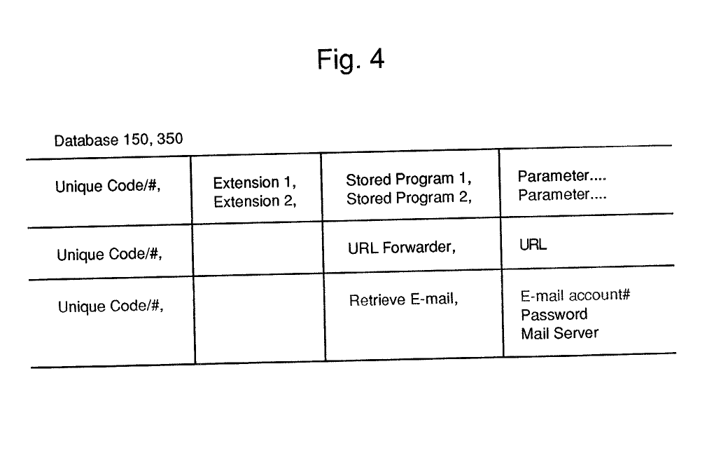

Referring to FIG. 4 for a preferred embodiment in implementing the database 150 of FIG. 1. The first column of the data entries lists an Internet user represented by and identifiable as a unique code provided as unified access code or a number, e.g., a telephone number. Associated with each unique identifier are an e-mail forwarding address and account, and other parameters associated with that e-mail address account such as list of senders that should be treated with special priority. When the unified access management center receives an incoming e-mail from a sending Internet user, the incoming e-mail designates the unique code, i.e., the unified access number, as part of the e-mail destination at the domain name associated with the unified access management center. The e-mail is sent to the associated forwarding e-mail address. When the unified access management center receives an incoming e-mail in the form of SMTP or other mail format, the forwarding e-mail address from the associated accounts provided in the database are retrieved and the e-mail is sent to the forwarding address. For each of the unique identifier, an extension may also be entered to invoke execution of stored programs to perform particular functions with the parameters provided in the database. These extensions could be real extensions or virtual extensions. Virtual extensions are those that are created in the Unified access management center for the purpose of activating stored programs. The stored program can also map to the main number with out the extension. The parameters used to execute different programs may also be sent in the mail included in the content of the mail or provided in the subject of the e-mail. The stored program may include functions such as detecting a sender's e-mail address to match with a priority list for sending the electronic mail with special priority treatment that may include sending an alert message to a pager of particular telephone number to display the e-mail message, etc. A registered user with the unified access management center can therefore access and change the programs of the database and parameter to carry out different functions. By applying a single unique identifier provided with several extension code, an Internet user registered with unified access code is enabled to perform many different functions conveniently. These functions can be carried out without requiring the registered unified access Internet user to manipulate the input devices for entering long list of program invocation commands and parameters in order to execute these programs.

The unified access-management center as described above can include several types of server supporting HTTP or SMTP protocols to carry out the registration, to process incoming e-mails, and to invoke and process stored programs using the store parameters or parameters included in the e-mails. The unified access management center is also provided to forward the e-mail to different Internet users or perform stored programs which is not limited to functions related to electronic mail delivery by carrying out function such as turning on a light.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A method for sending an e-mail from a sending Internet user to a receiving Internet user comprising:
a) said sending Internet user sending an e-mail to a control Web site designating an e-mail destination address represented by an Internet-independent unique identifier related to said receiving Internet user; and
b) said control Web site searches a database to find an e-mail forwarding address corresponding to said Internet-independent unique identifier for forwarding said e-mail to said receiving Internet user.

2. The method of claim 1 wherein:
said step a) of said sending Internet user sending an e-mail to said control Web site is a step a1) of said sending Internet user sending said e-mail designating said user-input Internet-independent unique identifier as said e-mail destination address at an Internet domain name of said control Web site (e-MailDestination@DomainName).

3. The method of claim 1 wherein:
said step b) further comprising a step b1) of said control Web site converting said e-mail destination address to a normalized e-mail destination address as said Internet-Independent unique identifier for said control Web site to search a database to find an e-mail forwarding address for forwarding said e-mail to said receiving Internet user.

4. The method of claim 1 wherein:
said step a) of said sending Internet user designating an e-mail destination address represented by an Internet-independent unique identifier is a step a2) of said sending Internet user designating a telephone number of said receiving Internet user as said e-mail destination address.

5. The method of claim 4 wherein:
said step a2) of said sending Internet user designating a telephone number of said receiving Internet user as said e-mail destination address is a step a3) of designating said telephone number as an e-mail destination address at an Internet domain name of said control Web site (e-MailDestination@DomainName).

6. The method of claim 1 wherein:
said step a) of said sending Internet user designating an e-mail destination address represented by an Internet-independent unique identifier is a step a4) of said sending Internet user designating said user-input Internet-independent unique identifier as an advertisement identifier number of said receiving Internet user.

7. The method of claim 6 wherein:
said step a4) of said sending Internet user designating said user-input Internet-independent unique identifier as an advertisement identifier number of said receiving Internet user is a step a5) of designating said advertisement identifier number as an e-mail destination address at an Internet domain name of said receiving Internet user.

8. The method of claim 1 wherein:
said step a) of said sending Internet user designating an e-mail destination address represented by an Internet-independent unique identifier related to said receiving Internet user is a step a6) of said sending Internet user designating a branch location name of said receiving Internet user as said user-input Internet-independent unique identifier.

9. The method of claim 8 wherein:
said step a6) of said sending Internet user designating a branch location name of said receiving Internet user as said user-input Internet-independent unique identifier is a step a7) of designation said branch location name as an e-mail destination address at an Internet domain name of said control Web site.

10. A network system comprising:
a unified access management center comprising a database for storing paired data for linking a network-independent preexisting-unique identifier to an e-mail forwarding address.

11. The network system of claim 10 wherein:
said unified access management center further comprising an incoming e-mail processor for processing an incoming e-mail designating an e-mail destination address related to said network-independent preexisting-unique identifier for searching said database for providing an e-mail forwarding address stored in said database.

12. The network system of claim 10 wherein:
said unified access management center further comprising a unified access registration processor for receiving a registration request comprising a network-independent preexisting-unique identifier and an associated e-mail forwarding address for storing in said database.

13. The network system of claim 11 wherein:
said network-resource request-input processor further comprising an e-mail destination address normalizing means for normalizing and converting an e-mail destination address into a normalized e-mail destination address.

14. The network system of claim 11 wherein:
said network-resource request-input processor further comprising an e-mail destination address processing means for receiving and processing an incoming e-mail directing to an e-mail destination address at an Internet domain name of said unified access management center.

15. The network system of claim 10 further comprising:
an e-mail forwarding means for forwarding said e-mail to said e-mail forwarding address retrieved from said database.

16. A network system comprising:
a unified access management center provided with an interactive database for enabling an Internet user to edit an unique linking pointer for linking a unified access code to an e-mail address of said Internet user.
